(19) United States
(12) Patent Application Publication
(10) Pub. No.: US 2016/0107308 A1
(43) Pub. Date: Apr. 21, 2016

(54) TOOL BIT TRAY

(71) Applicant: Shao-Hsien Hsu, Taichung City (TW)

(72) Inventor: Shao-Hsien Hsu, Taichung City (TW)

(21) Appl. No.: 14/514,397

(22) Filed: Oct. 15, 2014

(51) Int. Cl. B25H 3/06; B25H 3/00

(52) U.S. Cl. CPC B25H 3/06; B25H 3/003

(57) ABSTRACT

A tool bit tray for storage of at least one tool bit, wherein the tool bit has in its periphery at least one notch in which a snap ring of a tool bit socket may elastically snap. The tool bit tray includes a board and at least one retaining rib. The board defines at least one bore for reception of the tool bit. The retaining rib is formed integrally at a predetermined position on an inner wall of the bore corresponding to that of the notch of the tool bit. As such, when the tool bit is inserted in the bore of the board, the retaining rib may snap in the notch of the tool bit to constrain the tool bit from vertical displacement.

### BACKGROUND OF THE INVENTION

1. Field of the Invention

The present invention relates to a tool bit tray for storing tool bits, and more particularly to a tool bit tray with retaining means for holding the tool bits in an organized manner.

2. Description of the Related Art

Tool bit trays for storing tool bits such as drill bits, screwdriver bits, and the like are known. A conventional tool bit tray may simply define a plurality of bores therein to receive tool bits. The shapes of the bores in the tray may vary from circle, triangle, rectangle or hexagon for positioning of the tool bits. Due to the poor design, however, it may sometimes be difficult for the tool bits to firmly retained in the bores of the tray.

Another type of tool bit trays typically includes an elastic retaining means for holding the tool bits in an organized manner. Due to the elasticity of the retaining means, the retaining means exerts a counter force onto the tool bit to retain the tool bit within the bore of the tray. However, it may sometimes be difficult for a user to grasp and remove the tool bits from the retaining means because the tool bits are grasped by the retaining means too tightly.

### SUMMARY OF THE INVENTION

Accordingly, it is an object of the present invention to provide a tool bit tray, which allows tool bits to be firmly retained therein and easily removed therefrom.

To achieve the foregoing objective, a tool bit tray is provided for storing at least one tool bit. It should be noted that the tool bit has a notch defined in a periphery thereof such that, while in use, a tool bit socket may engage the tool bit with a snap ring elastically snapping in the notch of the tool bit. The tool bit includes a board and at least one retaining rib.

Specifically, the board defines at least one bore for reception of the tool bit(s). The retaining rib is formed integrally at a predetermined position on an inner wall of the bore corresponding to that of the notch of the tool bit in such a way that when the tool bit is inserted in the bore of the board, the retaining rib may snap into the notch of the tool bit to constrain the tool bit from vertical displacement.

Preferred embodiments of the invention may have the following additional characteristics, either alone or in combination:

The bore of the board is hexagonal with a periphery of alternating three odd edges and three even edges. Three confining lips may extend radially inward from the respective three odd edges of the bore of the board and surround the bore for constraining a hexagonal shank of the tool bit from horizontal displacement.

Each of the confining lips has an elongated middle portion and two bent end portions. The elongated middle portion is joined to the related odd edge of the bore of the board. The two bent end portions extend from opposite ends of the elongated middle portion and are joined to the respective even edges of the bore of the board.

In this preferred embodiment, there are six retaining ribs employed. Each of the retaining ribs is formed at a junction between the elongated middle portion and an adjacent one of the bent end portions to be mated with a vertex of the hexagonal bore of the board.

A bracket may extend downward from the periphery of the bore of the board for upholding the tool bit. The bracket includes a base and three pillars. The base has a generally three-pointed star shape to include three horizontal branches. The three pillars respectively extend upward from end portions of the three horizontal branches of the base to the periphery of the bore of the board. More specifically, the three pillars are respectively joined to the three even edges of the periphery of the bore of the board. And, each of the three pillars defines in a top thereof a cutout to keep one of the confining lips apart from another.

Further benefits and advantages of the present invention will become apparent after a careful reading of the detailed description with appropriate reference to the accompanying drawings.

### BRIEF DESCRIPTION OF THE DRAWINGS

FIG. 1 is a top perspective view of a tool bit tray in accordance with the preferred embodiment of the present invention;

FIG. 2 is a bottom perspective view of the tool bit tray in FIG. 1;

FIG. 3 is another perspective view of the tool bit tray in FIG. 1, partially cut away to show the interior of the tool bit tray;

FIG. 4 is a partial enlarged view of the tool bit tray in FIG. 3 together with tool bits;

FIG. 5 is a top view of one of tool bit seats in the tray of FIG. 1;

FIG. 6 is a top perspective view of the tool bit seat in FIG. 5;

FIG. 7 is a bottom view of the tool bit seat in FIG. 6;

FIG. 8 is a bottom perspective view of the tool bit seat in FIG. 6; and

FIG. 9 is an exploded perspective view of a conventional tool bit socket in conjunction with a conventional tool bit.

### DETAILED DESCRIPTION OF EMBODIMENTS

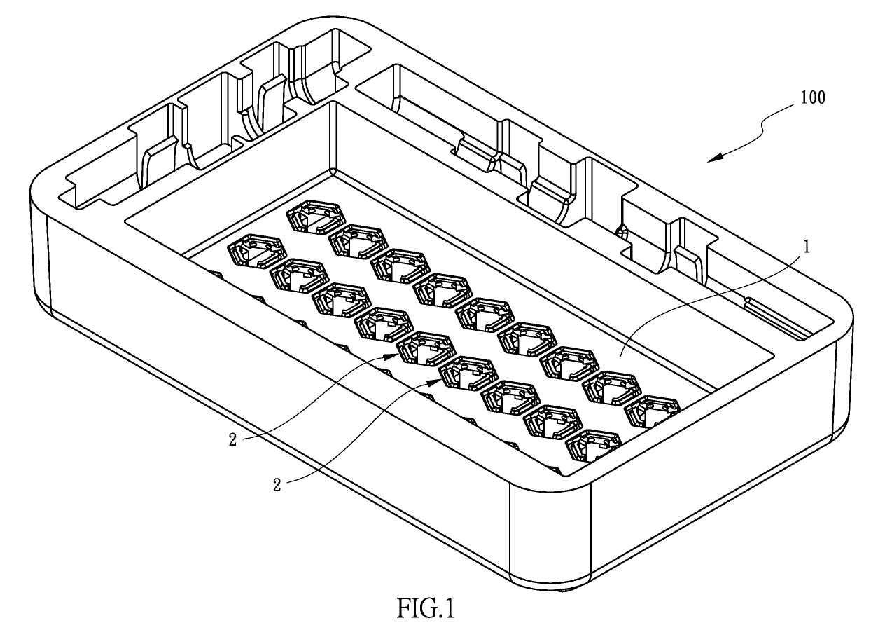

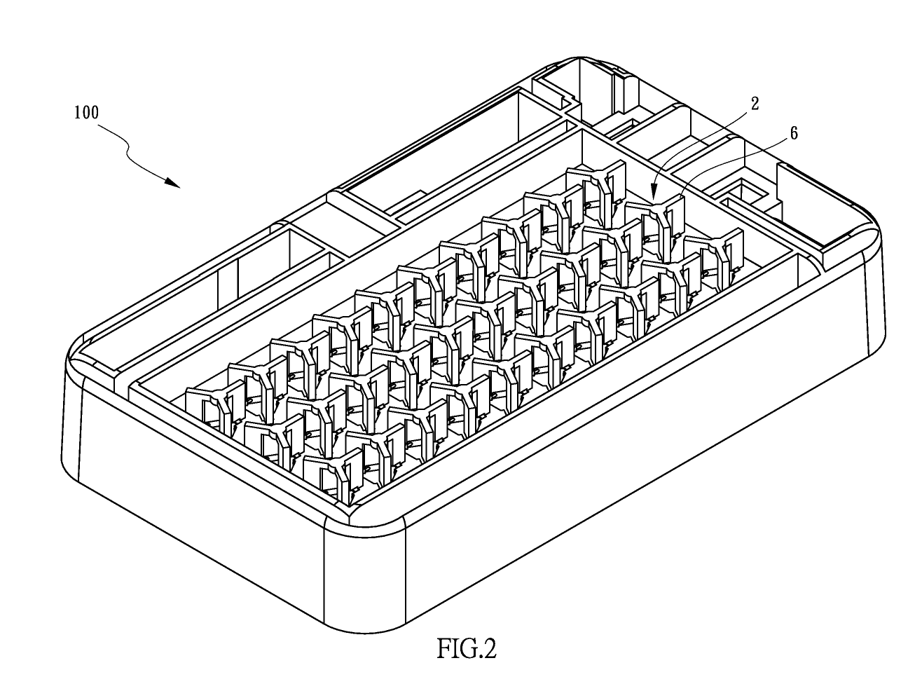

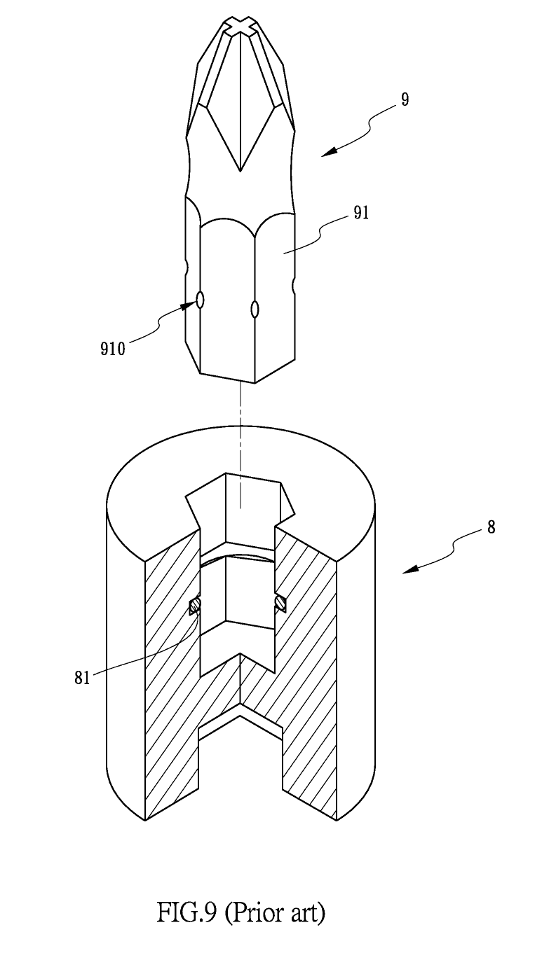

Referring to FIGS. 1 and 2, there is shown a preferred embodiment of the tool bit tray 100. The tool bit tray 100 is provided for storage of at least one tool bit 9. As shown in FIG. 9, the tool bit 9 has a hexagonal shank 91 that defines at least one notch 910 in a periphery thereof. In this way, a snap ring 81 equipped inside a tool bit socket 8 may elastically snap into the notch 910 of the tool bit 9 for engagement of the socket 8 and the tool bit 9. Due to the elasticity of the snap ring 81, the user may detach the tool bit 9 from the socket 8 by exerting a force in a direction away from the socket 8. As will be discussed in detail later, the present invention has been inspired by the tiny notch 910 to provide a best solution for properly retaining the tool bit 9 in the tray 100.

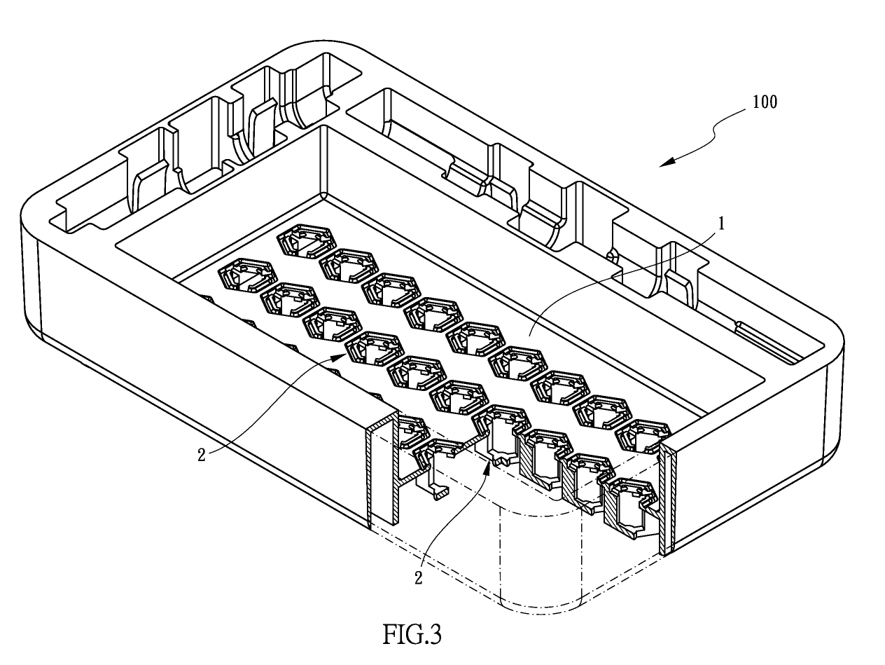

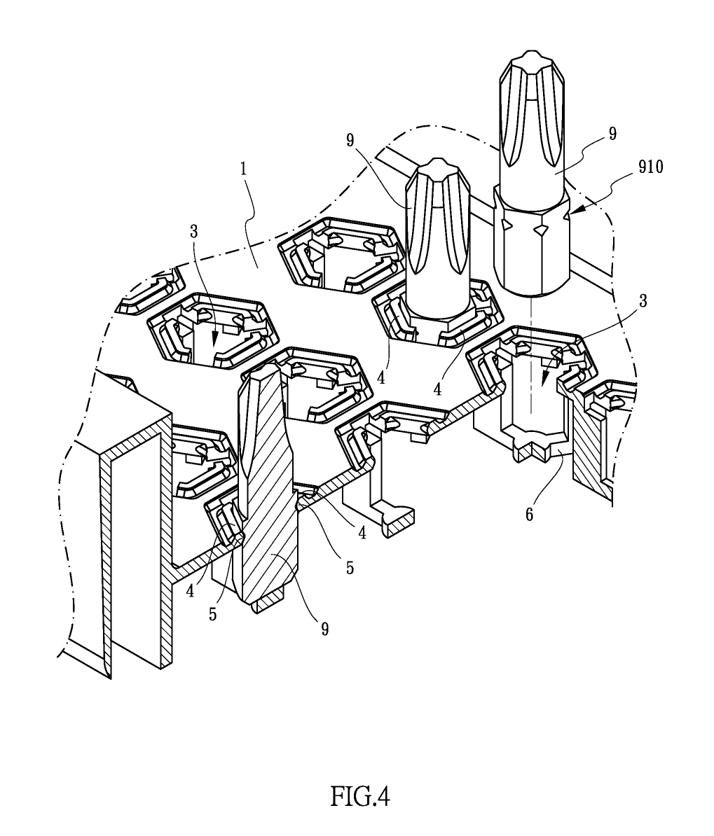

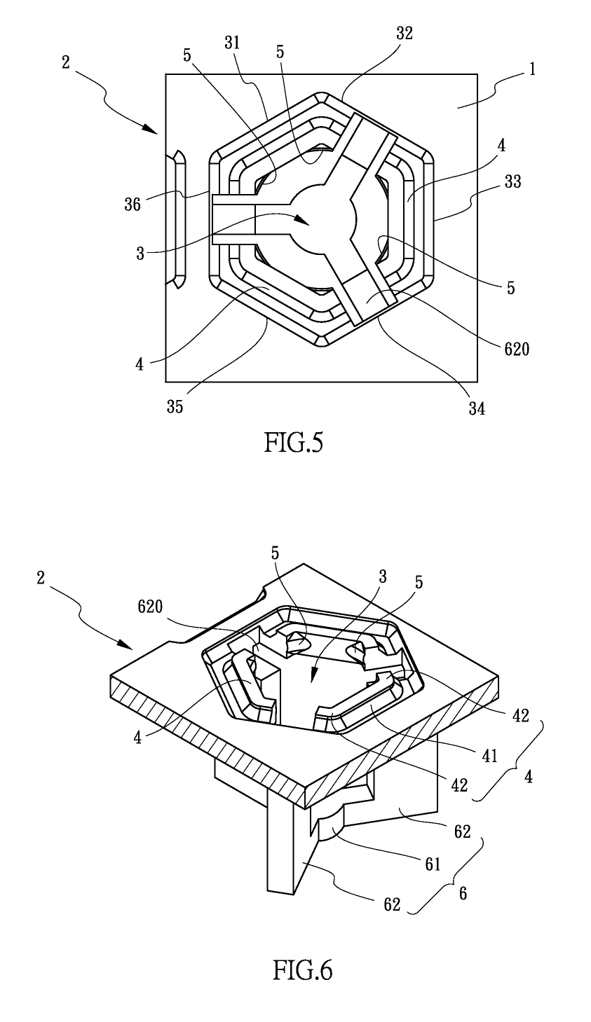

As shown in FIG. 3, the tool bit tray 100 includes a board 1 and a plurality of tool bit seats 2 arranged on the board 1 for reception of the tool bit(s) 9. Referring to FIG. 4 and further to FIG. 6, each of the tool bit seats 2 includes a bore 3, three confining lips 4, six retaining ribs 5 and a bracket 6. The bore 3 is defined in the board 1 and is hexagonal to receive the hexagonal shank 91 of the tool bit 9. As shown in FIG. 5, the bore 3 in the board 1 has a periphery of alternating three odd edges 31, 33, 35 and three even edges 32, 34, 36.

Referring back to FIG. 4, the three confining lips 4 extend radially inward from the respective three odd edges 31, 33, 35 of the bore 3 and surround the bore 3 for constraining the hexagonal shank 91 of the tool bit 9 from horizontal displacement. Specifically, as shown in FIG. 6, each of the confining lips 4 includes an elongated middle portion 41 and two bent end portions 42 extend from opposite ends of the elongated middle portion 41. The elongated middle portion 41 is joined to the related odd edge 31, 33 or 35 of the bore 3 in the board 1. The two bent end portions 42 are joined to the respective even edges 32, 34 or 36 of the bore 3 in the board 1.

As shown in FIG. 5 or 6, each of the retaining ribs 5 is formed at a junction between the elongated middle portion and an adjacent one of the bent end portions so as to be mated with a vertex of the hexagonal bore of the board. In particular, each of the retaining ribs 5 is formed integrally at a predetermined position on an inner wall of the bore 3 corresponding to that of the related notch 910 of the tool bit 9 such that when the tool bit 9 is inserted in the bore 3 in the board 1, each of the retaining ribs 5 may snap in the notch 910 of the tool bit 9 to constrain the tool bit 9 from vertical displacement, as depicted in FIG. 4. As a result of the resilience of the confining lips 4, the user may simply grasp and remove the tool bit 9 from the retaining ribs 5 by exerting a force in a direction away from the tool bit seat 2.

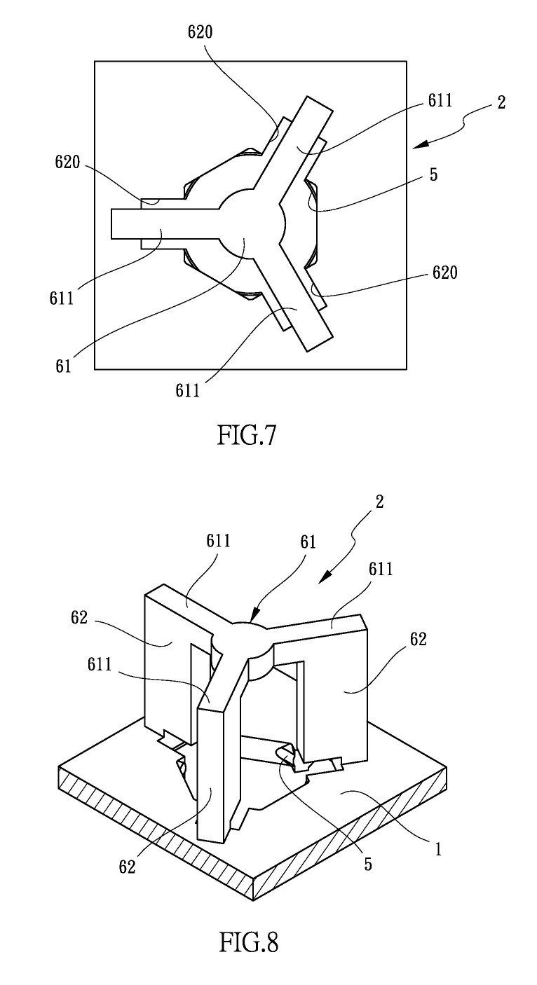

Referring to FIG. 6, the bracket 6 generally extends downward from the periphery of the bore 3 of the board 1 for upholding the tool bit 9 from the bottom. More specifically, as shown in FIGS. 7 and 8, the bracket 6 includes a base 61 and three pillars 62. The base 61 has a generally three-pointed star shape to include three horizontal branches 611. The three pillars respectively extend upward from end portions of the three horizontal branches 611 of the base 61 to the periphery of the bore 3 of the board 1. In this preferred embodiment, the three pillars 62 are respectively joined to the three even edges 32, 34, 36 of the periphery of the bore 3 of the board 1. Besides, each of the three pillars 62 defines in a top thereof a cutout 620 to keep one of the three confining lips 4 apart from another so that the confining lips 4 become resilient as desired.

As described above, the tool bit tray 100 according to the present invention is ingeniously inspired by the small notch 910 in the tool bit 9 to provide the confining lips 4 for properly retaining the tool bit 9 in the tray 100. Because of that, the tray 100 allows the tool bit 9 to be firmly retained in the tool bit seat 2 and easily removed therefrom.

What is claimed is:

1. A tool bit tray for storage of at least one tool bit, wherein the tool bit has in its periphery at least one notch in which a snap ring of a tool bit socket may elastically snap, the tool bit tray comprising:
a board defining at least one bore for reception of the tool bit; and
at least one retaining rib formed integrally at a predetermined position on an inner wall of the bore corresponding to that of the notch of the tool bit such that when the tool bit is inserted in the bore of the board, the retaining rib snaps in the notch of the tool bit to constrain the tool bit from vertical displacement.

2. A tool bit tray as recited in claim 1, further comprising three confining lips, wherein the bore of the board is hexagonal with a periphery of alternating three odd edges and three even edges; and the three confining lips extend radially inward from the respective three odd edges of the bore of the board and surround the bore for constraining a hexagonal shank of the tool bit from horizontal displacement.

3. A tool bit tray as recited in claim 2, wherein each of the confining lips has an elongated middle portion joined to the related odd edge of the bore of the board, and two bent end portions extend from opposite ends of the elongated middle portion and are joined to the respective even edges of the bore of the board.

4. A tool bit tray as recited in claim 3, wherein the at least one retaining rib includes six retaining ribs each being formed at a junction between the elongated middle portion and an adjacent one of the bent end portions so as to be mated with a vertex of the hexagonal bore of the board.

5. A tool bit tray as recited in claim 2, further comprising a bracket which extends downward from the periphery of the bore of the board for upholding the tool bit.

6. A tool bit tray as recited in claim 5, wherein the bracket includes a base and three pillars; the base has a generally three-pointed star shape to include three horizontal branches; and the three pillars respectively extend upward from end portions of the three horizontal branches of the base to the periphery of the bore of the board.

7. A tool bit tray as recited in claim 6, wherein the three pillars are respectively joined to the three even edges of the periphery of the bore of the board.

8. A tool bit tray as recited in claim 7, wherein each of the three pillars defines in a top thereof a cutout to keep one of the confining lips apart from another.
